(19) United States
(12) Patent Application Publication
(10) Pub. No.: US 2018/0194017 A1
(43) Pub. Date: Jul. 12, 2018

(54) DEPTH CONTROLLABLE CUTTING APPARATUS

(71) Applicant: Eric Yeh-Wei TSEO, Seattle, WA (US)

(72) Inventor: Eric Yeh-Wei TSEO, Seattle, WA (US)

(21) Appl. No.: 15/402,161

(22) Filed: Jan. 9, 2017

(51) Int. Cl. B26B 1/04; B26B 5/00

(52) U.S. Cl. CPC B26B 1/042; B26B 5/006; B26B 5/005; B26B 5/003

(57) ABSTRACT

Technologies and implementations for a cutting apparatus configured to have cutting depths be controllable are generally disclosed.

### INFORMATION

Cutting implements have been around for a very long time. Some examples of cutting implements may include cutting implements utilizing a blade. For example, cutting implements utilizing a blade may be used in a variety of applications such as, but not limited to, surgery, food preparation, butchering, shaving, precision cutting, opening packages, etc. Some of these applications may involve cutting to predetermined depths.

For example, increasingly people shop for all manner of products and/or services online. For example, a person may shop online for a wide range of products such as, but not limited to, mobile phone cases, 60-inch televisions, clothes, etc. and have the product delivered some place (e.g., delivered to a person's residence). Commonly, the product may be delivered packaged in some form of packaging. An example of packaging may be a box such as, but not limited to, a cardboard box. Another example of packaging may be a plastic type packaging such as, but not limited to, heat-sealed plastic blister packs, clamshells, etc. Once delivered, the packages may be commonly opened using a variety of methods including the use of a cutting implement utilizing a blade. However, opening the packages may have some challenges.

Some of the challenges in opening various packages may include ensuring that the product inside is not damaged during the opening. Another challenge may be the actual difficulty in cutting through the tough plastic package. In one example, opening a cardboard box may include the risk of damaging (e.g., cutting) the product inside. One example of damage may be a cut in a cereal box. In another example, cutting through a plastic packaging may be difficult unless sufficient force is applied, which may result in cutting beyond the thickness of the packaging and potentially damaging the product.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates an isometric view of a cutting apparatus, in accordance with various embodiments;

FIG. 2 illustrate a side view of the cutting apparatus shown in FIG. 1;

FIG. 3 illustrates an isometric view of a cutting apparatus, in accordance with various embodiments of the present disclosure;

FIG. 4 illustrates a side view of the cutting apparatus described with respect to FIG. 3;

FIGS. 5A and 5B illustrate a back view and a front view of the cutting apparatus shown in FIG. 3, respectively;

FIGS. 6A and 6B illustrate a bottom view and a top view of the cutting apparatus shown in FIG. 3, respectively;

FIG. 7, illustrates cutting apparatus in accordance with some alternate embodiments;

FIG. 8 illustrate a side view of the cutting apparatus shown in FIG. 7;

FIG. 9 illustrates a cutting apparatus configured to utilize a generic utility blade, in accordance with various embodiments; and

FIG. 10 illustrates a side view of the cutting apparatus shown in FIG. 9.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to apparatus, and systems related to a cutting apparatus configured to have cutting depths be controllable.

Cutting implements utilizing blades may be used in a variety of applications. As previously mentioned, some example applications may include applications such as, but not limited to, food preparation, surgery, butchering, shaving, precision cutting, opening packages, etc., and some applications may include cutting to predetermined depths. The ability to control the depth of the cut may help facilitate an improved package removal and/or less likelihood of product damage.

Before turning to the figures, a non-limiting example application of the various embodiments of the present disclosure may be described. In the non-limiting example, a product such as, but not limited to, a number of cereal in boxes may be delivered to a store packaged in a single packaging cardboard box. The packaging cardboard box may be cut open using a cutting implement such as, but not limited to, a box cutter. People who have bought cereal in boxes may appreciate that there may be times when a cereal box may have a cut on its surface. One reason for the cut on the surface of the cereal box may be due to a blade of the box cutter having cut into the packaging cardboard box beyond the thickness of the walls of the packaging cardboard box. As will be described in detail, the likelihood of a cereal box having a cut on its surface may be reduced in accordance with various embodiments. For example, in various embodiments, a cutting apparatus may be configured to facilitate control of cutting depth. In one example, control of cutting depth may be facilitated by application of force by a user. In another example, control of cutting depth may be facilitated by a wedge type structure. In yet another example, control of cutting depth may be facilitated by a combination of force by a user and a wedge type structure. It will be evident from the present disclosure that the claimed subject matter is not limited to the examples described so far, and accordingly, the claimed subject matter is not limited in these respects.

It should be appreciated that the above non-limiting example application may have been described with respect to opening a packaging cardboard box, but it should be appreciated that various embodiments may be applicable to a wide variety of applications such as, but not limited to, surgery (i.e., cutting skin/tissue), cutting paper (e.g., wallpaper, envelopes, etc.), cutting open food related packaging (e.g., potato chip bags, cereal bags, lidded film tubs, etc.), cutting related to arts and crafts, cutting inlays in surfaces (e.g., wood, plastic, metal, etc.), children safe cutting implements, sculpting, cutting to remove air from air pillow packaging, dowel cutting, and/or any other application where control of cutting depth and/or safety may be applicable. Accordingly, the claimed subject matter is not limited in these respects.

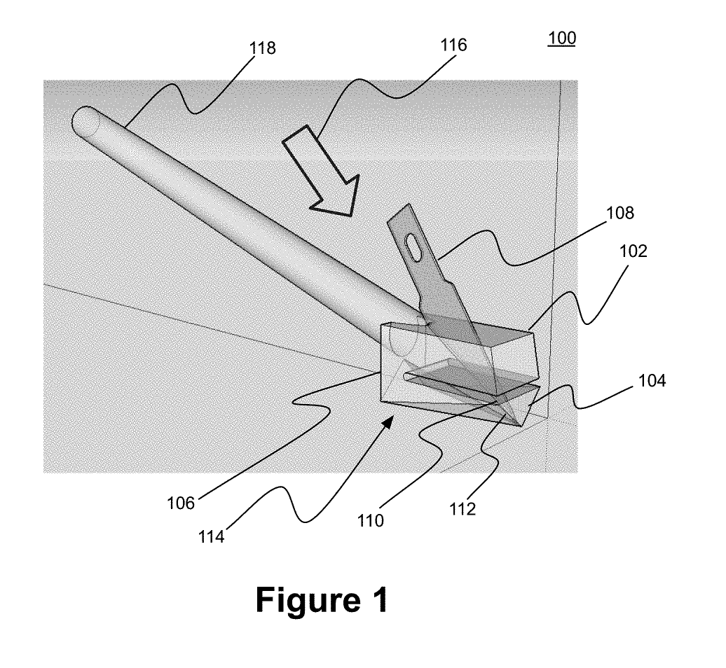

Turning now to FIG. 1, where an isometric view of a cutting apparatus is illustrated, in accordance with various embodiments. In FIG. 1, a cutting apparatus 100 may be shown as a translucent model in order to fully appreciate and understand the disclosed subject matter. The cutting apparatus 100 may include a first member 102, a second member 104, and a third member 106. Shown in FIG. 1, the cutting apparatus 100 may include a blade 108. The first member 102 may be configured to secure the blade 108. The second member may be configured to receive an end 110 of the blade 108. Additionally, the second member may be configured to facilitate a tip 112 of the end 110 of the blade 108 to protrude a predetermined distance out of a cutting surface 114 of the second member 104. In FIG. 1, the third member 106 may be shown disposed between the first member 102 and the second member 104. Additionally, as shown, the third member 106 may be configured to flex under a predetermined load 116 to cause the tip 112 of the end of the blade 110 to protrude the predetermined distance out of the cutting surface 114 of the second member 104. Additionally shown in FIG. 1 is a handle 118 with which the predetermined load 116 may be applied. As a result, the cutting apparatus 100 may be configured to have cutting depths be controllable, in accordance with various embodiments.

As shown, the blade 110 may be of a utility type such as, but not limited to, X-Acto™ type cutting tool available from Elmer's Products, Inc. of Westerville, Ohio.

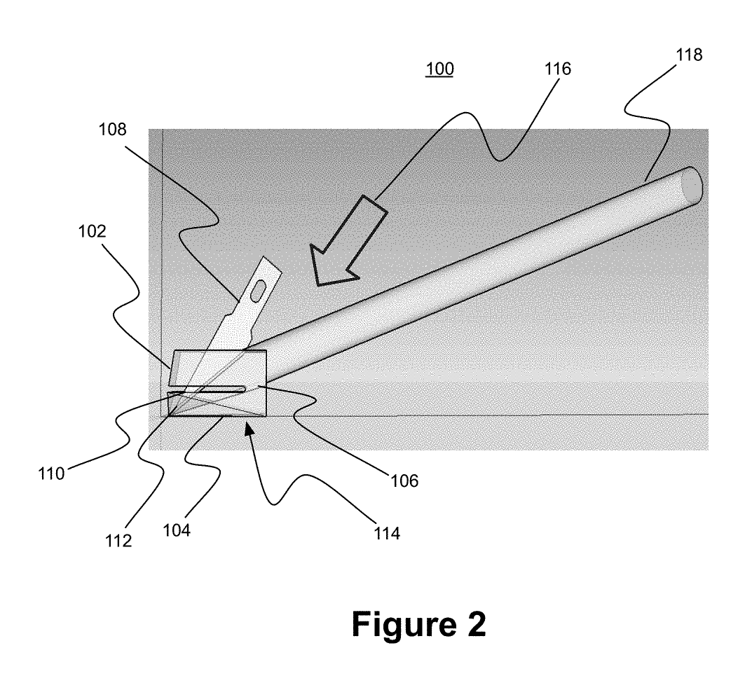

FIG. 2 illustrate a side view of the cutting apparatus shown in FIG. 1. Continuing to show the cutting apparatus as a translucent model, it can be shown in FIG. 2 the first member 102 securing the blade 108. As will be described with respect to some of the following figures, the blade 108 may be secured in a variety of manners. In the one example shown in FIGS. 1 and 2, the third member 106 may comprise a U-bend structure. Continuing to refer to FIG. 2, in a non-limiting example scenario, the cutting apparatus 100 may be placed upon a surface of a packaging such as, but not limited to, a cardboard box. A user may apply the load 116 via the handle 118 (e.g., push the cutting apparatus towards the box by pressing against the box). The application of the load may cause the third member 106 to flex causing the first member 102 to bend towards the second member 104 thereby causing the tip 112 of the end 110 of the blade to protrude a predetermined distance out of the cutting surface 114 of the second member 104. In one example, the predetermined distance may be controlled by the amount of load 116 applied by the user (e.g., strength). In another example, the predetermined distance may be controlled mechanically such as, but not limited to, a wedge type structure. The wedge type structure may help facilitate prevention of the tip 112 of the end 110 of the blade 108 from protruding a predetermined distance (e.g., a mechanical stop).

In one example, the first member 102 and the second member 103 may have a slot for the blade 108. In one example, the slot may be configured to secure a razor type blade. In another example, the slot may be configured to secure a utility type blade. It is contemplated within the scope of the present disclosure that a slot may be of a wide variety of configurations to accommodate a wide range of blades such as, but not limited to, blades for surgery, food preparations, opening plastic packages, opening cardboard boxes, opening food packages, arts and crafts related applications, etc., and accordingly, the claimed subject matter is not limited in these respects.

Shown in FIGS. 1 and 2, the cutting apparatus 100 may comprise of the first member 102, the second member 104, and the third member 106 being integrated as a single unit. However, it is contemplated within the scope of the present disclosure that the cutting apparatus 100 may comprise of a variety of configurations such as, but not limited to, the first member 102, the second member 104, and/or the third member being separate units and/or any combination thereof, and accordingly, the claimed subject matter is not limited in these respects.

Before moving on, it should be noted that it may be evident that some of the features of the disclosed subject matter may be applicable to a wide variety of applications and/or configurations. Moving forward some features and/or components/units of the disclosed cutting apparatus may be omitted to not obscure the disclosed subject matter and fully describe the disclosed subject matter. Some of variations and applications may also be illustrated with respect to the following Figures.

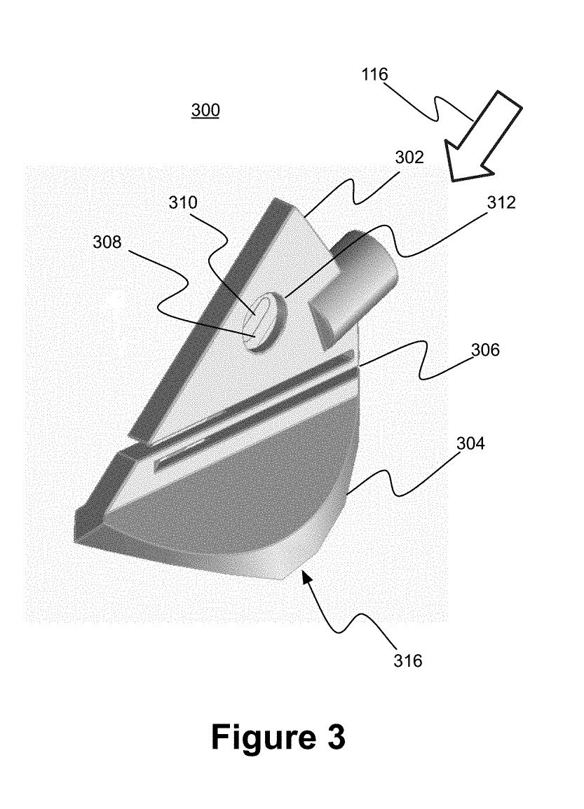

FIG. 3 illustrates an isometric view of a cutting apparatus, in accordance with various embodiments of the present disclosure. In FIG. 3, a cutting apparatus 300 may be shown as a solid model. The cutting apparatus 300 may include a first member 302, a second member 304, and a third member 306. The cutting apparatus 300 may include a blade 308. As shown, the blade 308 may include a securing hole 310, which may be configured to secure the blade 308 into various enclosures and/or holding apparatuses. Additionally, the cutting apparatus 300 may include a pinhole 312 in the first member 302. As shown, the pinhole 312 may be substantially aligned with the securing hole 310 on the blade 308. A securing device such as, but not limited to, a pin (not shown) may be utilized to placed through the pinhole 312 and through the securing hole 310 thereby securing the blade 308 within the first member 302.

In FIG. 3, the third member 306 may be of a flex structure configured to flex under a predetermined load 314. In one example, the flex structure shown may comprise of a zigzag bend type structure. The application of the predetermined load 314 may cause the third member 306 to flex (e.g., compress) thereby causing the first member 302 to bend into the second member 304. This action may cause the end of the blade 308, where the pin may have secured the blade to the first member 302, to extend into the second member 304 thereby causing a tip of the blade 308 to protrude a predetermined distance out of a cutting surface 316 of the second member 304. As previously described, the load 314 and/or the configuration of the third member 306 may facilitate the determination of the predetermined distance of protrusion. For example, referring back to FIGS. 1 and 2, the third member 106 may comprise of a U-bend type structure. The U-bend type structure of the third member 106 may require less of a load to flex than the zigzag bend type structure of the third member 306 shown in FIG. 3. The third members 106 and 303 may have a wide variety of configurations such as, but not limited to, V-bend type structure, serpentine bend type structure, spring type structure (e.g., coil springs), L-bend type structure, etc., and accordingly, the claimed subject matter is not limited in these respects.

In addition to and/or alternatively, the material composition of the third members 106 and 306 may affect the load that may flex the third members 106 and 306. For example, the third members 106 and 306 may be made of a wide variety of material such as but not limited to, plastic material, metal material, wood material, paper material, etc., and accordingly, the claimed subject matter is not limited in these respects.

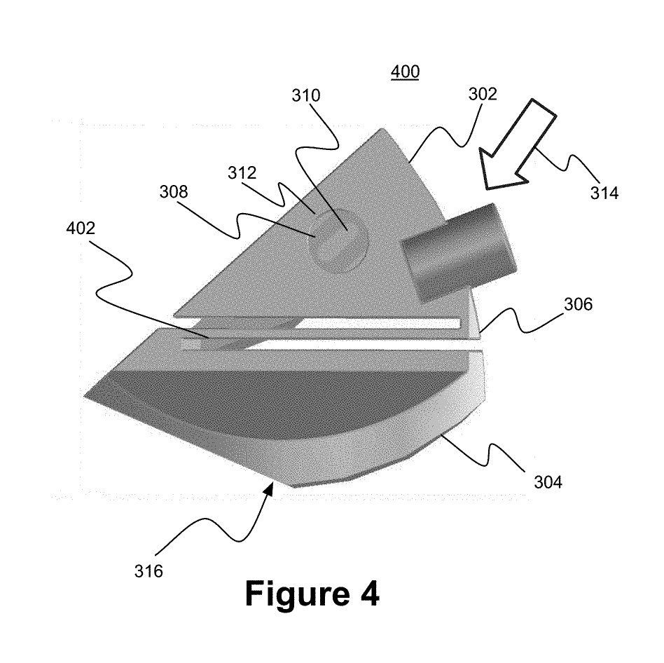

FIG. 4 illustrates a side view of the cutting apparatus described with respect to FIG. 3. In FIG. 4, a side view 400 of the cutting apparatus 300 may include showing the components described with respect to FIG. 3. However, in FIG. 4, the side view 400 may show an end 402 of the blade 308 received by the second member 304.

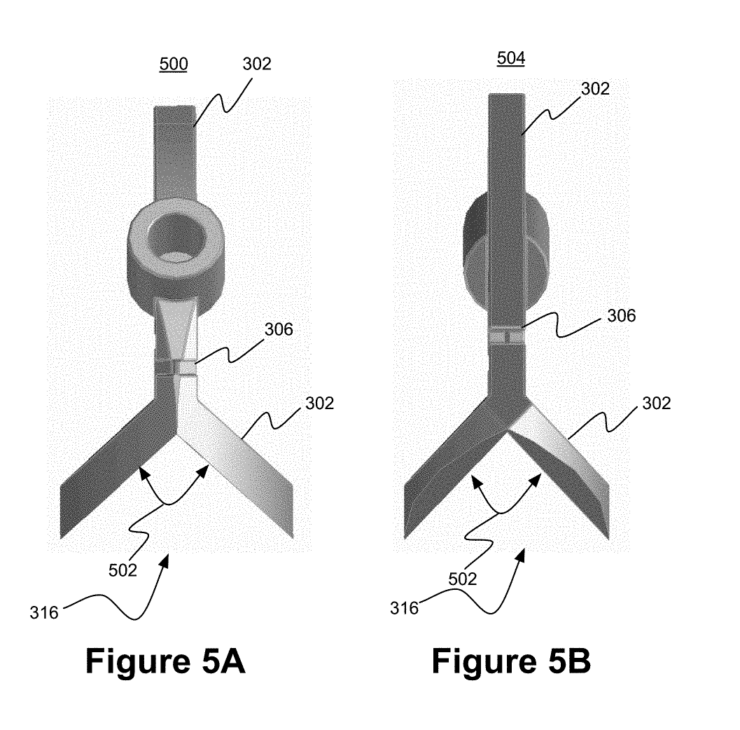

FIGS. 5A and 5B illustrate a back view and a front view of the cutting apparatus shown in FIG. 3, respectively. In FIG. 5A, a back view 500 of the cutting apparatus 300 may include showing the components described with respect to FIG. 3. However, in FIG. 5A, the back view 500 may show the cutting surface 316 of the second member 302 having an angle 502. The angle 502 may be configured to accommodate a corner of a packaging such as, but not limited to, a cardboard box. The angle 502 may facilitate cutting a surface of the cardboard box as will be described later. In FIG. 5B, a front view 504 of the cutting apparatus 300 may include showing the components described with respect to FIG. 3 including the angle 502.

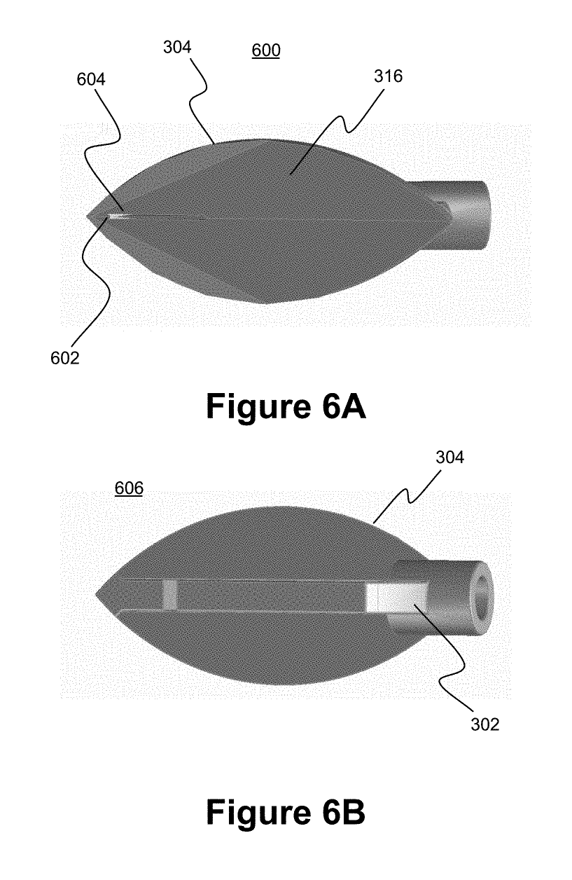

FIGS. 6A and 6B illustrate a bottom view and a top view of the cutting apparatus shown in FIG. 3, respectively. In FIG. 6A, a bottom view 600 of the cutting apparatus 300 may include showing the components described with respect to FIG. 3. However, in FIG. 6A, the bottom view 600 may show the cutting surface 316 of the second member 304 having a slit 602. Additionally, the bottom view 600 may show a tip 604 of the end 402 of the blade 308. In FIG. 6A, the tip 604 may be shown protruding out of the slit 602 of the cutting surface 316 of the second member 304. In FIG. 6B, a top view 606 of the cutting apparatus 300 may include showing the components described with respect to FIG. 3. However, in FIG. 6B, the top view 600 may show the overall shape of the cutting apparatus 300 to be approximately ovoid. It should be apparent from the disclosure that the shape of cutting apparatus may be a wide variety of shapes and sizes within the spirit and scope of the disclosure. Accordingly, the claimed subject matter is not limited in these respects.

In one non-limiting example, a user may place the cutting surface 316 onto a corner of a cardboard box. The user may press against the first member 302 causing the third member 306 to flex (e.g., compress). The tip 604 may protrude out of the slit 602 thereby cutting into the corner of the cardboard box. The user may pull the cutting apparatus along the corner guided by the angle 502. If the cardboard box is rectangular, the user may repeat this process three more times thereby cutting open a side of the cardboard box. Because of the protrusion of tip 604 out of the slit 602 may be controlled by the load 314, the depth of the cut may be controlled. The likelihood of damage to the product inside the cardboard box may be reduced. When the user removes the cutting apparatus 300 from the cardboard box, the third member 306 may spring back to its original position causing the tip 604 to retract into the second member 304, in accordance with various embodiments of the present disclosure. Accordingly, the cutting apparatus 300 may reduce the likelihood of having the tip 604 exposed when not in use (i.e., safely store the blade).

Continuing with the non-limiting example of a cardboard box, the predetermined distances may include approximately 0.8 millimeters to approximately 4.8 millimeters. In some other examples, the predetermined distance may be different such as, but not limited to, surgical settings, where the predetermined distances may include approximately 2 millimeter to approximately 3 millimeters. In some other examples including those of plastic packaging (e.g., polyvinyl chloride, polyethylene terephthalate, etc.), the predetermined distances may include approximately 0.18 millimeters to approximately 1.2 millimeters. Accordingly, the claimed subject matter is not limited in these respects.

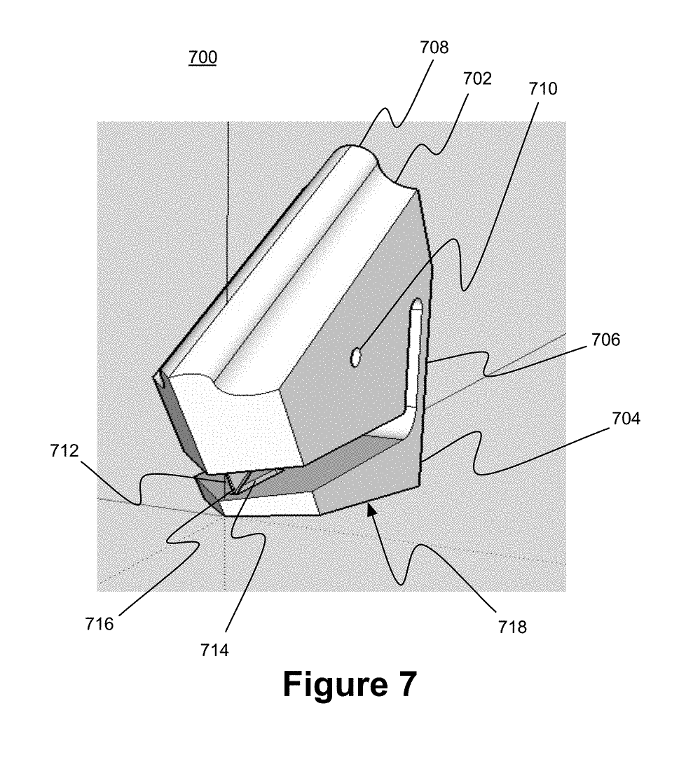

FIG. 7, illustrates cutting apparatus in accordance with some alternate embodiments. In FIG. 7, an isometric view of a cutting apparatus 700 may include a first member 702, a second member 704, and a third member 706. Additionally, the first member 702 may include a ridge 708. The ridge 708 may be configured to facilitate providing structural support for the cutting apparatus. For example, more though cutting situations. The cutting apparatus 700 may include a pinhole 710, which may be similar to the pinhole 312 (shown in FIG. 3). The cutting apparatus 700 may include a blade 712. In the example shown in FIG. 700, the blade 712 may be a razor type blade. Since the blade may have a rectangular shape, the first member 702 may be configured to accommodate the rectangular shape of the blade 712. Also shown in FIG. 7, the second member 704 may include a slit 714 for a tip 716 of the blade 712 to protrude through a cutting surface 718.

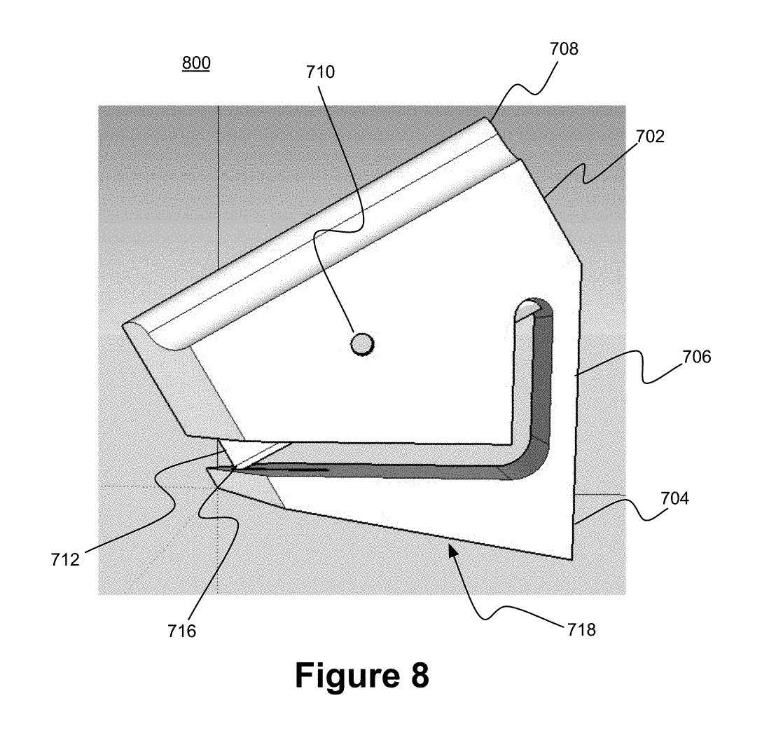

FIG. 8 illustrate a side view of the cutting apparatus shown in FIG. 7. In FIG. 8, a side view 800 of the cutting apparatus 700 may include showing the components described with respect to FIG. 7. However, in FIG. 8, the side view 800 may show the third member 706 having an L-bend structure, where the L-bend structure may be configured to flex under a predetermined load, in accordance with various embodiments of the present disclosure.

Even though the present disclosure may have been described with respect to a tip of a blade protruding out of a cutting surface, it is contemplated within the spirit and scope of the present disclosure that the claimed subject matter may include any part of the blade such as, but not limited to, the whole cutting edge of the blade protruding out of the cutting surface, and accordingly, the claimed subject matter is not limited in these respects.

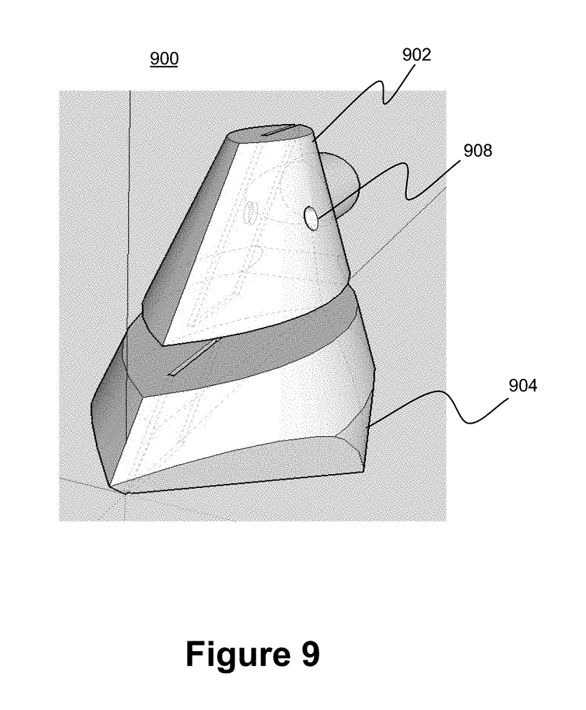

FIG. 9 illustrates a cutting apparatus configured to utilize a generic utility blade, in accordance with various embodiments. Shown in FIG. 9 is an isometric view of a cutting apparatus 900. The cutting apparatus 900 may include various components previously described. For example, the cutting apparatus 900 may include a first member 902 a second member 904, and a pinhole 908. Additionally, the cutting apparatus 900 may have an overall shape substantially similar to an ovoid wedge.

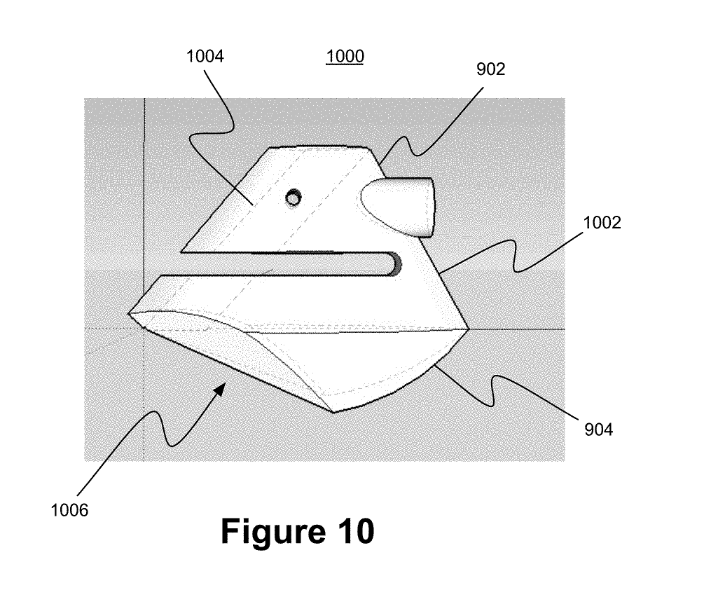

FIG. 10 illustrates a side view of the cutting apparatus shown in FIG. 9. In FIG. 10, a side view 1000 of the cutting apparatus 900 may include showing the components described with respect to FIG. 9. However, in FIG. 10, the side view 1000 may show a third member 1002 having an L-bend structure, where the L-bend structure may be configured to flex under a predetermined load, in accordance with various embodiments of the present disclosure. Additionally, the cutting apparatus 1000 may be shown with a slot 1004 extending from a top of the first member 902 through to a cutting surface 1006 on the second member 904. As shown, the slot 1004 may be configured to accommodate a substantially generic utility blade.

It should be appreciated that it is contemplated within the scope and spirit of the present disclosure that the claimed subject matter may include a wide variety of blade and blade types such as, but not limited to, metal blades, ceramic blades, polymer blades, etc. Accordingly, the claimed subject matter is not limited in these respects.

In some portions of the description, illustrative implementations of the disclosure may have been described with reference to the elements of the components described with respect to FIGS. 1-10. However, the described embodiments are not limited to these depictions. More specifically, some elements/components depicted in FIGS. 1-10 may be omitted from some implementations detailed herein. Furthermore, other elements not depicted in FIGS. 1-10 may be used to implement example apparatuses detailed herein.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. An apparatus comprising:
a first member, the first member configured to secure a blade;
a second member, the second member configured to receive an end of the blade and facilitate a tip of the end of the blade to protrude a predetermined distance out of a cutting surface of the second member; and
a third member, the third member disposed between the first member and the second member and configured to flex under a predetermined load to cause the tip of the end of the blade to protrude the predetermined distance out of the cutting surface of the second member.

2. The apparatus of claim 1, wherein the first member comprises a first member having a slot for the blade.

3. The apparatus of claim 2, wherein the slot comprises a slot configured to secure a razor type blade.

4. The apparatus of claim 2, wherein the slot comprises a slot configured to secure a utility type blade.

5. The apparatus of claim 1, wherein the first member comprises a first member having a pinhole configured to secure the blade.

6. The apparatus of claim 1, wherein the second member comprises a second member having a slit configured to facilitate the tip of the end of the blade to protrude the predetermined distance out of the cutting surface of the second member.

7. The apparatus of claim 1, wherein the second member comprises a second member having a wedge type structure, the wedge type structure configured to facilitate protrusion of the tip of the end of the blade the predetermined distance out of the cutting surface of the second member.

8. The apparatus of claim 1, wherein the second member comprises a second member having an angled cutting surface.

9. The apparatus of claim 8, wherein the angled cutting surface comprises a cutting surface having a slit, the slit configured to facilitate the protrusion of the tip of the end of the blade the predetermined distance out of the cutting surface and proximately located at an apex of the angled cutting surface.

10. The apparatus of claim 1, wherein the third member comprises a U-bend type structure, the U-bend type structure configured to flex under the predetermined load.

11. The apparatus of claim 1, wherein the third member comprises a flex spring structure, the flex spring structure configured to flex under the predetermined load.

12. The apparatus of claim 1, wherein the third member comprises a zigzag bend type structure, the zigzag bend type structure configured to flex under the predetermined load.

13. The apparatus of claim 1, wherein the third member comprises a coil spring structure, the coil structure configured to flex under the predetermined load.

14. The apparatus of claim 1, wherein the predetermined distance is approximately 0.8 millimeters to approximately 4.8 millimeters.

15. The apparatus of claim 1, wherein the predetermined load is a load exerted by a user.

16. The apparatus of claim 1, wherein the third member comprises an L-bend type structure, the L-bend type structure configured to flex under the predetermined load.
